(19) United States
(12) Patent Application Publication
(10) Pub. No.: US 2025/0094955 A1
(43) Pub. Date: Mar. 20, 2025

(54) POINT-OF-SALE TERMINAL, METHOD, AND MEDIUM

(71) Applicant: Toshiba Tec Kabushiki Kaisha, Tokyo (JP)

(72) Inventor: Yuishi TAKENO, Numazu Shizuoka (JP)

(21) Appl. No.: 18/757,409

(22) Filed: Jun. 27, 2024

(30) Foreign Application Priority Data
Sep. 15, 2023 (JP) 2023-150493

(51) Int. Cl. G06Q 20/20

(52) U.S. Cl. CPC G06Q 20/208

(57) ABSTRACT

A point-of-sale terminal includes an interface connectable to an imaging device, a memory that stores feature data representing a feature of an image of each item sold in a store, the feature data being associated with an item code of each item, and a processor configured to: control the imaging device to capture an image, perform a process on the image to read an item code of an item in the image, perform feature extraction on the image to acquire first feature data representing a feature of the item, search the memory for second feature data associated with the item code, based on the first and second feature data, determine whether a package of the item was changed, upon determining that the package of the item was not changed, register the item for purchase, and upon determining that the package of the item was changed, issue a notification.

### CROSS-REFERENCE TO RELATED APPLICATION(S)

This application is based upon and claims the benefit of priority from Japanese Patent Application No. 2023-150493, filed Sep. 15, 2023, the entire contents of which are incorporated herein by reference.

### FIELD

Embodiments described herein relate generally to a point-of-sale (POS) terminal, a method, and a medium.

### BACKGROUND

With the decline in the working population, as part of measures to save labor at stores such as supermarkets, a self-service checkout system such as a self-service POS system has been introduced in which customers themselves register purchased items (hereinafter also referred to as “item registration”) and settle the purchased items. In addition, as a new form, a checkout system of a moving type has been used in which customers themselves perform item registration while moving inside a store.

In the moving type of checkout system, a customer performs item registration by using a terminal device, such as a smartphone or a tablet terminal attached to a shopping cart, to read a code symbol such as a bar code attached to a target item for purchase through its camera or code reader. In recent years, there has also been proposed a technique of performing item registration using an object recognition technique of recognizing a type of an item from an image thereof captured by a camera. In such an object recognition technique, the appearance feature of a target item is extracted from an image of the item captured by the camera, and is compared with the features of a plurality of types of items registered in dictionary data for collation, to find the type of the target item having the similar feature.

Meanwhile, packages of items sold at stores may be changed at timing of seasonal changes, campaign execution, and the like. When a package of an item changes, its appearance feature also change, and thus there is a possibility that the item cannot be correctly recognized using the object recognition technique. Therefore, when a package of an item is changed, it is necessary to re-register or update the feature of that item in the dictionary data.

However, a store may not be aware of such a change of a package, and the dictionary data may be used without being updated. In particular, in the above-described checkout system of a moving type, since the customers themselves perform item registration, store clerks of the store may not notice the change of the package.

### SUMMARY OF THE INVENTION

Embodiments of the present disclosure provide a POS terminal, a method, and a medium that enable a store and its clerks to easily notice the changes in the packages of the items sold in the store.

In one embodiment, a POS terminal comprises an interface circuit connectable to an imaging device; a memory that stores feature data representing a feature of an image of each of items that are sold in a store, the feature data being associated with an item code of said each of items; and a processor configured to: control the imaging device to capture an image, perform a code reading process on the image to read an item code of an item shown in the image, perform feature extraction on the image to acquire first feature data representing a feature of the item shown in the image, search the memory for second feature data that is associated with the read item code, based on a difference between the first and second feature data, determine whether a package of the item was changed since the second feature data was stored in the memory, upon determining that the package of the item was not changed, register the item for purchase, and upon determining that the package of the item was changed, issue a notification.

### BRIEF DESCRIPTION OF THE DRAWINGS

FIG. 1 is a diagram of a checkout system according to an embodiment.

FIG. 2 is a side view of a configuration of a shopping cart according to an embodiment.

FIG. 3 is a hardware configuration diagram of a terminal device according to an embodiment.

FIG. 4 is a data configuration diagram of an item master according to an embodiment.

FIG. 5 is a data configuration diagram of a sales registration table according to an embodiment.

FIG. 6 is a hardware configuration diagram of a server according to an embodiment.

FIG. 7 is a functional configuration diagram of the terminal device and the server.

FIG. 8 is a flowchart of a sales registration process performed by the terminal device.

FIG. 9 is a sequence diagram of a data update process performed by the terminal device and the server.

### DETAILED DESCRIPTION

Hereinafter, various embodiments of this disclosure will be described in detail with reference to the accompanying drawings. In the following embodiments, a terminal device attached to a shopping cart used for carrying items in a store (hereinafter, also referred to as a cart) will be described as an example of an item registration device. Note that the invention is not limited by this application example.

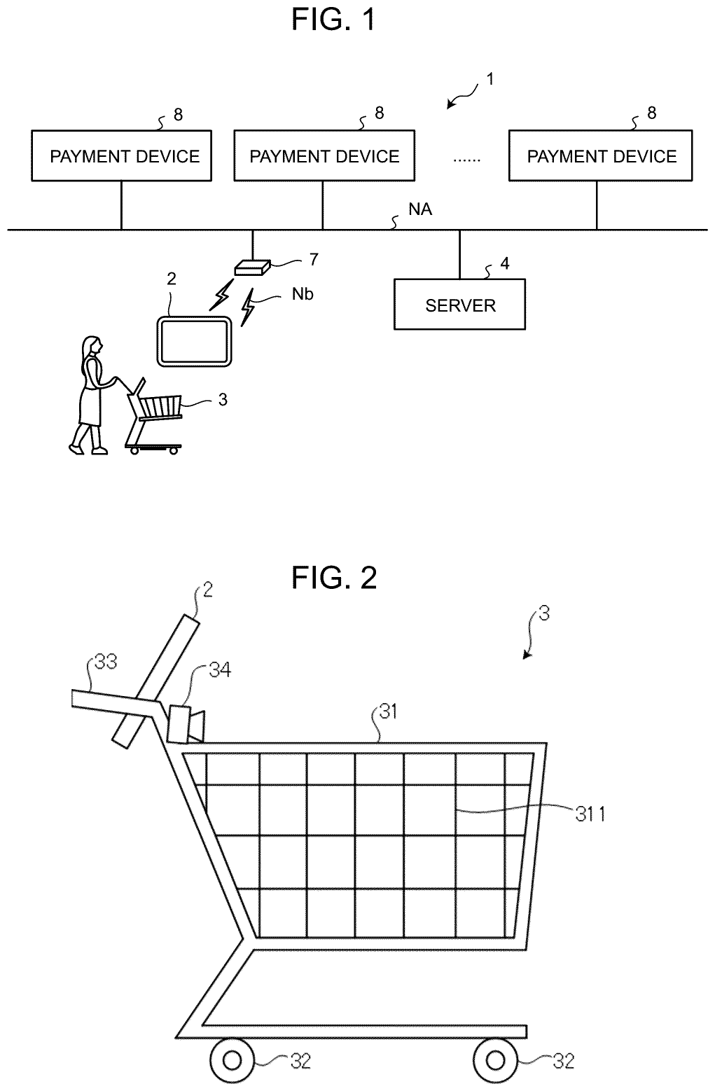

FIG. 1 is a diagram illustrating an example of a checkout system 1 according to an embodiment. As illustrated in FIG. 1, the checkout system 1 includes a terminal device 2, a server 4, and a plurality of payment devices 8. The servers 4 and the payment devices 8 are communicably connected via a networked Na.

As the network Na, the Internet, a virtual private network (VPN), a local area network (LAN), a public communication network, a mobile communication network, or the like can be used singly or in combination as appropriate. As the network Na, the Internet and a mobile communication network are used in combination.

Also connected to the networked Na is a wireless access point 7. The wireless access point 7 is connected to the terminal device 2 via a networked Nb such as a wireless LAN. Therefore, the terminal device 2 can communicate with the server 4 and the payment devices 8.

The cart 3 includes a storage unit 31 (see FIG. 2) such as a basket that stores items to be purchased in a store. An upper portion of the storage unit 31 is opened, and an item is inserted into the storage unit 31 from the upper portion. A customer of a store walks around the store with the cart 3, takes items displayed in the store, and stores them in the storage unit 31 of the cart 3.

The terminal device 2 is a mobile terminal such as a tablet-type POS terminal operated by the customer who is using the cart 3. In the present embodiment, the terminal device 2 is attached to the cart 3 and is operated by the customer.

The terminal device 2 recognizes or specifies the type of an item inserted into the storage unit 31 from its image captured by the imaging unit 34, which will be described later, and executes a sales registration process related to the item. Here, the sales registration process is also referred to as item registration or the like, and means a process of determining an item specified by the terminal device 2 as a target item to be purchased. Specifically, the sales registration process refers to a process of registering information on the specified item in the sales registration table 243 described later. Hereinafter, the information on the item registered in the sales registration table 243 is also referred to as “sales registration data”.

In addition, when receiving an operation for performing payment of purchased items (hereinafter, also referred to as payment), the terminal device 2 executes a process for transmitting sales registration data for one transaction registered in the sales registration process to one of the payment devices 8. For example, the terminal device 2 encodes and displays the sales registration data into a code symbol such as a two-dimensional code. In this case, one of the payment devices 8 reads the code symbol displayed on the terminal device 2 to acquire the sales registration data for one transaction registered in the terminal device 2, and executes a payment process based on the sales registration data.

The server 4 may be, for example, a store server provided in a store or a server device provided outside the store. The server 4 of the present embodiment manages dictionary data and the like to be used in the package recognition process described later.

In one embodiment, the server 4 is a single device, but may be a cloud server or a cloud system including a plurality of devices connected to a network.

The payment devices 8 are payment devices for performing a payment process in a store. Each payment device 8 executes the payment process based on sales registration data. A payment process includes displaying the total amount of payment or tax of items related to one transaction, calculating and displaying the change based on the payment by a customer, issuing a receipt printed with item information and payment information (e.g., the total amount, the payment amount, the change amount, etc.). Note that, in the present embodiment, the payment device 8 is described as a self-service type payment device in which a customer who has performed a sales registration using the terminal device 2 can perform a payment process by his/her own operation, but the payment device is not limited to this, and may be an payment device operated by an employee such as a store clerk.

Next, the cart 3 will be described. FIG. 2 is a side view illustrating an example of the configuration of the cart 3. The cart 3 includes the storage unit 31 having an upper opening, rotating casters 32 disposed below the storage unit 31, a handle 33 connected to the storage unit 31 and gripped by a customer when the cart 3 is moved, and the like.

The storage unit 31 has a configuration in which the side surface and the bottom surface have a substantially square shape and a mesh-like grid 311, and the upper portion is opened so that an item stored in the storage unit 31 can be visually viewed from the outside. Note that the side surface and the bottom surface may be wall surfaces instead of the mesh-like grid 311.

The cart 3 includes the terminal device 2 in the vicinity of the handle 33. Further, the cart 3 includes the imaging unit 34 near the edge of the opening of the storage unit 31. The imaging unit 34 is an imaging device such as a digital camera. The imaging unit 34 is installed such that the imaging direction faces the opening of the storage unit 31. That is, the imaging direction and the imaging range are set so that the imaging unit 34 can capture an image of an item to be taken in and out of the storage unit 31. Note that the imaging unit 34 may be included in the terminal device 2.

The imaging unit 34 captures an image of an item stored in the storage unit 31 or an item taken out from the storage unit 31, and outputs the captured image to the terminal device 2. Here, the image means a still image or a video consisting of two or more frames.

Note that the configuration of the cart 3 is not limited to the illustrated example of FIG. 2. For example, the number of imaging units 34 is not limited to one, and a plurality of imaging units may be provided. In addition, the terminal device 2 may be configured to be detachably attached to the cart 3. In this case, the terminal device 2 may be carried by the customer himself or herself, or a portable terminal (a smartphone, a tablet terminal, or the like) provided by a store may be attached to the cart 3.

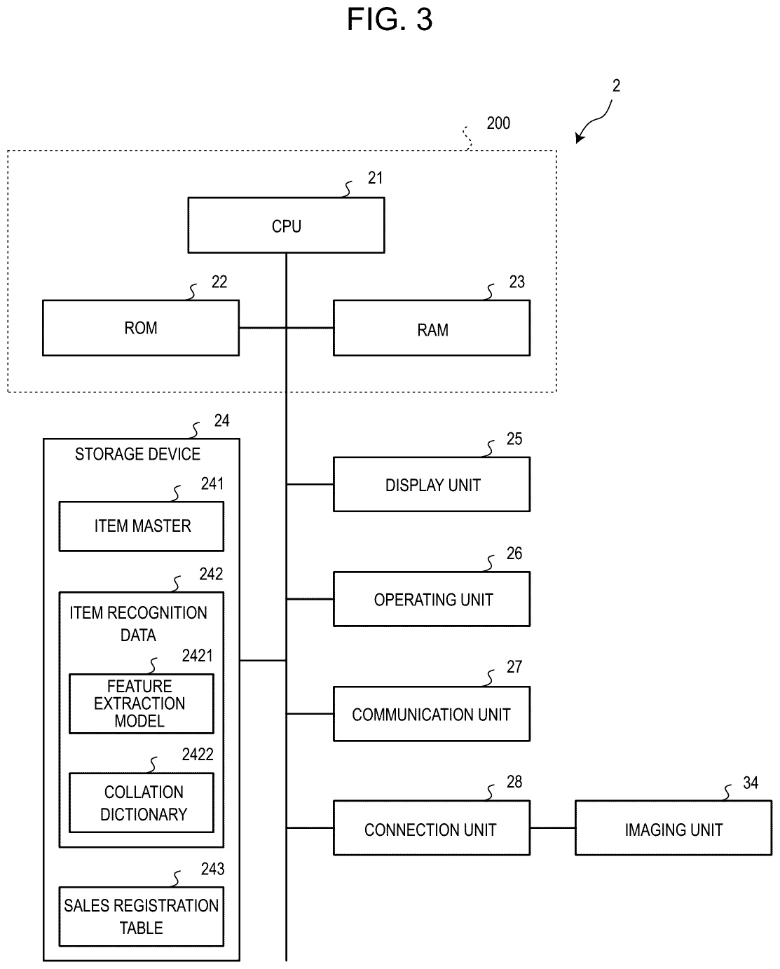

Hereinafter, a configuration example of a main device of the checkout system 1 will be described. First of all, a hardware configuration of the terminal device 2 will be described. FIG. 3 is a diagram illustrating an example of a hardware configuration of the terminal device 2.

As illustrated in FIG. 3, the terminal device 2 includes a central processing unit (CPU) 21, a read only memory (ROM) 22, a random access memory (RAM) 23, a storage device 24, a display unit 25, an operating unit 26, a communication unit 27, a connection unit 28, and the like.

The CPU 21 is a processor and comprehensively controls the operation of the terminal device 2. The ROM 22 stores various programs. The RAM 23 is a workspace for loading programs and various types of data.

The CPU 21, the ROM 22 and the RAM 23 are connected to each other via a bus or the like, and constitute a controller 200. The CPU 21 of the controller 200 executes various processes in accordance with a program stored in the ROM 22 or the storage device 24 and loaded into the RAM 23.

The storage device 24 includes a storage medium such as a hard disk drive (HDD) or a flash memory, and maintains data even if the power supply is cut off. The storage device 24 stores programs that can be executed by the CPU 21 and various types of setting data. For example, an application program for cooperating with the checkout system 1 is stored in the storage device 24 in advance.

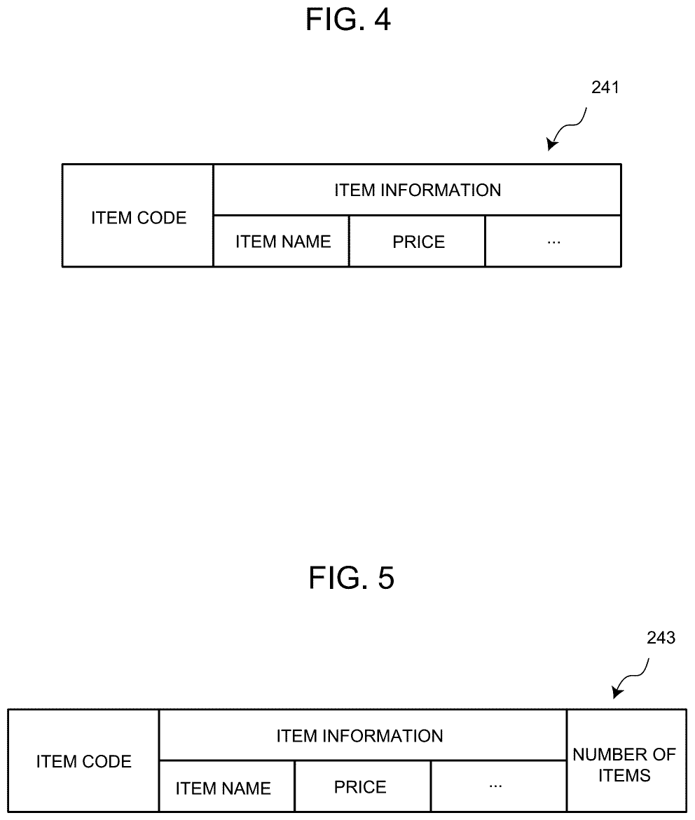

Further, the storage device 24 stores an item master database 241 (hereinafter simply referred to as the item master), item recognition data 242, and the like. The item master 241 is a database for storing and managing item information of the items sold at a store. FIG. 4 is a diagram illustrating an example of a data configuration of the item master 241. As illustrated in FIG. 4, the item master 241 stores an item code and item information in association with each other.

The item code is an example of identification information for identifying an item sold at a store. The item information is information on the item corresponding to the item code. The item information includes, for example, an item name, a price, and the like.

The item recognition data 242 is a data set for recognizing and identifying an item from the appearance feature of the item. Here, the appearance feature of an item include, for example, a design, an exterior, a pattern, a color tone, a texture, a shape, and the like of the item or its package. Hereinafter, a process of identifying an item code for identifying an item from the appearance feature thereof is also referred to as a “package recognition process”.

The item recognition data 242 includes, for example, a feature extraction model 2421 and a collation dictionary 2422.

The feature extraction model 2421 is a learned model trained to extract a feature (for example, a feature vector) representing an appearance feature of an item. When an image is input, the feature extraction model 2421 extracts and outputs a feature indicating an appearance feature of an item represented in the image. For example, a known technique such as Convolutional Neural Network (CNN) can be used to extract the feature.

The collation dictionary 2422 specifies the item corresponding to the feature based on the feature of the item extracted from the image. For example, the collation dictionary 2422 stores, for a plurality of items sold at a store, an item code corresponding to each item and a feature (hereinafter, also referred to as a collation feature) representing an appearance feature of the item in association with each other.

In the package recognition process, the feature of the item extracted from the image using the feature extraction model 2421 is compared with the feature for matching of each item registered in the collation dictionary 2422 to calculate the degree of similarity (also referred to as distance and likelihood) between the features. Then, in the package recognition processing, an item code in which the degree of similarity of the feature exceeds a threshold value (for example, 90%) among the items registered in the collation dictionary 2422 is specified as the item serving as the subject.

The storage device 24 stores a sales registration table 243. The sales registration table 243 is a data table for storing and managing items registered for sales in the terminal device 2. FIG. 5 is a diagram illustrating an example of a data configuration of the sales registration table 243.

As illustrated in FIG. 5, the sales registration table 243 stores item codes, item information, scores, and the like in association with each other. Here, in the data configuration of the sales registration table 243, for example, a set of an item code, an item name, item information, and a number corresponds to sales registration data.

The item code is an item code for identifying the item registered for sales, and corresponds to the item code registered in the item master 241. The item information stores item information (i.e., an item name, a price, and the like) of the item master 241 corresponding to the item code of the item registered for sales. The number means the quantity of the item registered in the sales.

Note that the data configuration of the sales registration table 243 is not limited to FIG. 5. For example, the sales registration table 243 may have a data configuration that does not hold item information.

Referring back to FIG. 3, the display unit 25 is a display device such as a liquid crystal display (LCD). The display unit 25 displays various types of information under the control of the CPU 21. The operating unit 26 is an input device such as a keyboard or a pointing device. The operating unit 26 receives an operation input via the input device and issues a signal corresponding to the operation, which is then detected by the CPU 21. The operating unit 26 may be a touch panel provided on the display unit 25.

The communication unit 27 is a wired or wireless communication interface circuit connectable to the network Nb. The communication unit 27 is communicably connected to the wireless access point 7 via the network Nb. The controller 200 communicates with an external device such as the server 4 and the payment device 8 via the communication unit 27.

The connection unit 28 is an interface circuit connectable to various peripheral devices. The connection unit 28 is a wired or wireless interface conforming to a standard of universal serial bus (USB) or short-range wireless communication such as Bluetooth (registered trademark). In the present embodiment, the connection unit 28 is connected to the imaging unit 34.

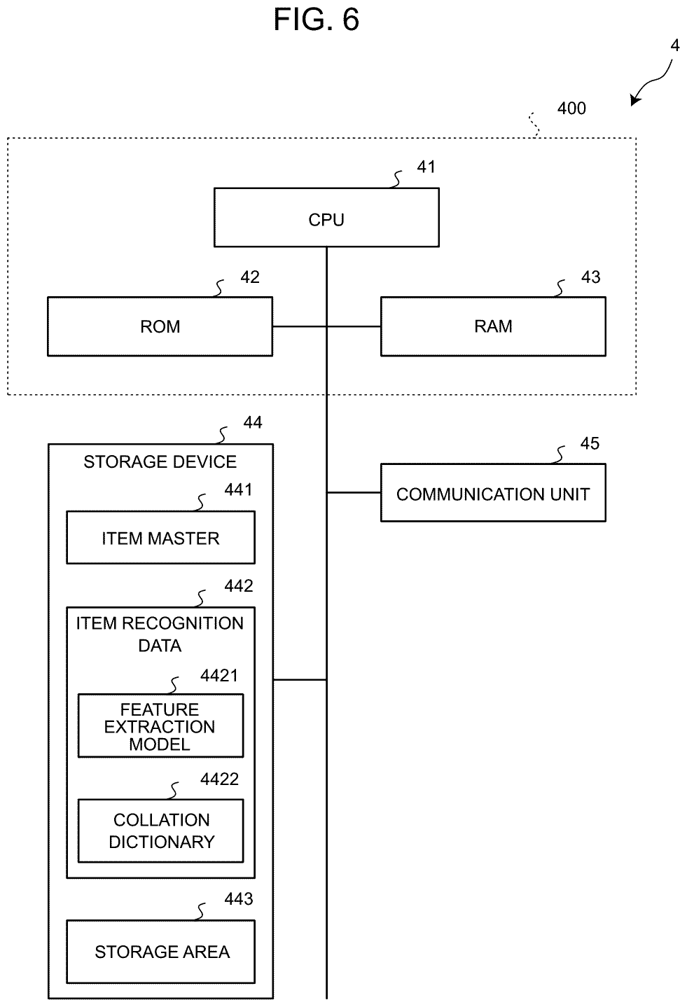

Next, a hardware configuration of the server 4 will be described. FIG. 6 is a diagram illustrating an example of the hardware configuration of the server 4.

As illustrated in FIG. 6, the servers 4 include a CPU 41, a ROM 42, a RAM 43, a storage device 44, a communication unit 45, and the like.

The CPU 41 is a processor and comprehensively controls the operation of the server 4. The ROM 42 stores various programs. The RAM 43 is a workspace for loading programs and various types of data.

The CPU 41, the ROM 42 and the RAM 43 are connected to each other via a bus or the like, and constitute a controller 400. The CPU 41 of the controller 400 executes various processes in accordance with a program stored in the ROM 42 or the storage device 44 and loaded into the RAM 43.

The storage device 44 includes a storage medium such as an HDD or a flash memory, and maintains data even if the power supply is cut off. The storage device 44 stores programs that can be executed by the CPU 41 and various types of setting data. For example, the storage device 44 stores various programs for performing a server function in the checkout system 1, such as a database program and a Web application program. Further, the storage device 44 may store various programs and the like for generating and updating the item recognition data 242.

Further, the storage device 44 stores an item master 441 and item recognition data 442. The item master 441 corresponds to the item master 241 described above. For example, the server 4 transmits a copy of the item master 441 to each of the terminal devices 2 used in the store as the item master 241 so that the same item master 441 is shared by the terminal devices 2 in the store.

The item recognition data 442 corresponds to the item recognition data 242 described above, and includes a feature extraction model 4421 and a collation dictionary 4422. For example, the server 4 transmits a copy of the item recognition data 442 to each of the terminal devices 2 in the store as the item recognition data 242 so that the same item recognition data 442 is shared by the terminal devices 2 in the store.

The storage device 44 includes a data storage area 443. The data storage area 443 is a data area for storing package update information, which will be described later, transmitted from the terminal device 2.

The communication unit 45 is a wired or wireless communication interface circuit connectable to the network Na. The communication unit is communicably connected to an external device such as the terminal device 2 and the payment device 8 via the network Na. The controller 400 communicates with an external device such as the terminal device 2 and the payment device 8 via the communication unit 45.

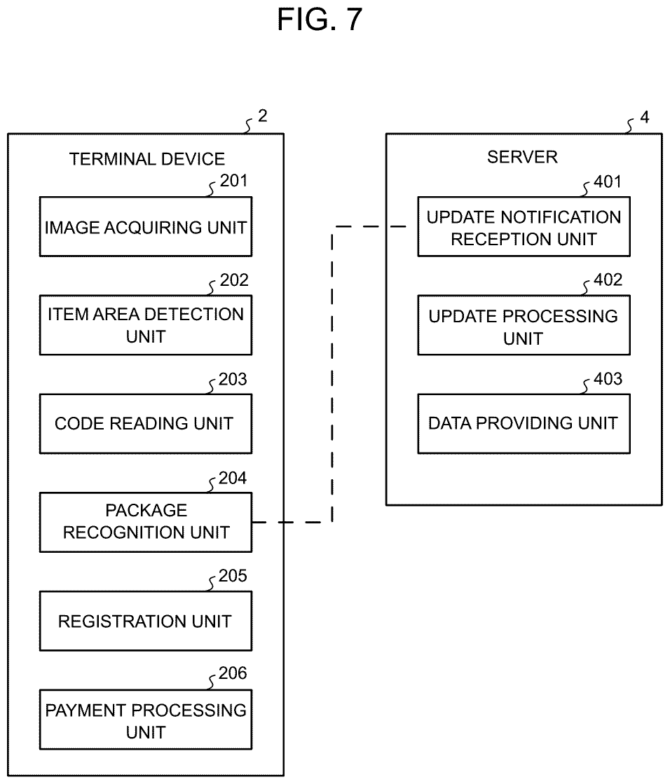

Next, functional configurations of the terminal device 2 and the server 4 will be described. FIG. 7 is a diagram illustrating an example of a functional configuration of the terminal device 2 and the server 4.

As illustrated in FIG. 7, the terminal device 2 performs the functions of an image acquiring unit 201, an item area detection unit 202, a code reading unit 203, a package recognition unit 204, a registration unit 205, and a payment processing unit 206.

Those functions of the terminal device 2 are performed by the CPU 21 of the terminal device 2 in accordance with a program stored in the ROM 22 or the storage unit 24, but the present disclosure is not limited thereto, and for example, some or all of the functionals of the terminal device 2 may be performed by hardware such as dedicated circuitry.

The image acquiring unit 201 acquires an image captured by the imaging unit 34 via the connection unit 28. The image acquired by the image acquiring unit 201 (hereinafter, also referred to as a captured image) is temporarily stored in the RAM 23 for processing in the code reading unit 203 and the registration unit 205.

The item area detection unit 202 detects a region in which an item is represented from the captured image. Specifically, the item area detection unit 202 detects a region in which an item is represented (hereinafter, also referred to as an item area) from the image acquired by the image acquiring unit 201, and outputs information representing the item area or the item area. It should be noted that a known object detection technique such as SSD (Single Shot multibox Detector) can be used as the method for detecting the item area.

Further, the item area detection unit 202 determines the moving direction of the item by detecting the position and motion (for example, motion vector) of the item area detected from each of the images acquired by the image acquiring unit 201 in time series. Specifically, the item area detection unit 202 determines whether the item has been moved downward or upward.

For example, when an item is placed in the storage unit 31, the item area detection unit 202 detects that the item has moved downward (hereinafter, also referred to as an inserting direction). When an item is taken out from the storage unit 31, the item area detection unit 202 detects that the item has moved upward (hereinafter, also referred to as a removal direction).

The code reading unit 203 reads information from a code symbol such as a bar code and a two-dimensional code included in a captured image. Specifically, the code reading unit 203 executes a code reading process for reading a code symbol in the item area detected by the item area detection unit 202.

In the code reading process, the code reading unit 203 extracts an image representing a code symbol from the item area, and decodes the extracted code symbol to obtain information represented by the code symbol. For example, the code reading unit 203 acquires an item code by reading a code symbol attached to an item.

The package recognition unit 204 recognizes the item represented in the captured image by executing the package recognition process on the captured image using the item recognition data 242.

Specifically, the package recognition unit 204 extracts or acquires the feature of the item represented in the item area from the item area by executing the package recognition process on the item area detected by the item area detection unit 202. Next, the package recognition unit 204 collates the extracted feature with the collation feature of each item registered in the collation dictionary 2422, thereby acquiring, from the collation dictionary 2422, an item code of an item whose degree of similarity exceeds a threshold value, and outputs the item code as a recognition result.

The registration unit 205 executes an item registration process or a registration cancellation process of an item based on the moving direction of the item determined by the item area detection unit 202, the item code read by the code reading unit 203, or the item code recognized by the package recognition unit 204.

When an item code is acquired by the code reading unit 203 or the package recognition unit 204 and the movement in the inserting direction is detected by the item area detection unit 202, the registration unit 205 executes an item registration process of registering the item corresponding to the item code in the sales registration table 243. Specifically, the registration unit 205 reads the item information corresponding to the item code acquired by the code reading unit 203 or the package recognition unit 204 from the item master 241, associates the item code with the quantity (initial value is 1), and registers it in the sales registration table 243. In addition, when the item code registered in the sales registration table 243 is acquired by the code reading unit 203 or the package recognition unit 204 and the movement in the inserting direction is detected by the item area detection unit 202, the registration unit 205 adds 1 to the quantity of the corresponding sales registration data.

In addition, when an item code is acquired by the code reading unit 203 or the package recognition unit 204 and the movement in the removal direction is detected by the item area detection unit 202, the registration unit 205 executes a registration cancellation process for cancelling the sales registration of the item corresponding to the item code. Specifically, the registration unit 205 searches the sales registration table 243 for sales registration data corresponding to the acquired item code, and subtracts the quantity of the retrieved sales registration data by one. In addition, when the result quantity of the subtraction becomes 0, the registration unit 205 deletes the sales registration data from the sales registration table 243.

Further, each time the sales registration table 243 is updated, the registration unit 205 causes the display unit 25 to display a screen based on the sales registration data registered in the sales registration table 243. For example, the registration unit 205 causes the display unit 25 to display a screen on which the registered items are listed.

As described above, in the checkout system 1 of the present embodiment, when a customer places an item in the storage unit 31 of the cart 3, the item registration of the item is automatically performed. Further, in the checkout system 1, the cancellation of the item registration is automatically performed by the customer taking out the item from the storage unit 31 of the cart 3. In other words, the checkout system 1 is a sales floor moving type of checkout system in which a customer can perform item registration by himself/herself while moving inside the store.

The payment processing unit 206 executes a process for settling the registered items in accordance with the operation by the customer. Specifically, the payment processing unit 206 performs a process for transmitting the sales registration data of the registered items to the payment device 8 such that the payment device 8 can perform a settlement process based on the sales registration data.

For example, when receiving an operation for instructing the end of the item registration via the operating unit 26 and an operation for instructing the start of the payment (hereinafter, also collectively referred to as a closing operation), the payment processing unit 206 controls the communication unit 27 to transmit the sales registration data registered in the sales registration table 243 to the payment device 8 by short-range wireless communication such as Bluetooth (registered trademark).

Further, for example, the payment processing unit 206 may control the communication unit 27 to transmit the sales registration data registered in the sales registration table 243 to the payment device 8 via the server 4. In this instance, the payment processing unit 206 controls the communication unit 27 to transmit the sales registration data registered in the sales registration table 243 to the servers 4 together with identification ID capable of identifying the terminal device 2 or identification ID capable of identifying the transaction. Further, the payment processing unit 206 controls the communication unit 27 to transmit the identification ID to the payment device 8 of the accounting destination by short-range wireless communication. Then, the payment device 8 inquires of the servers 4 about the identification ID transmitted from the payment processing unit 206 to acquire sales registration data corresponding to the identification ID.

It should be noted that the manner of notification the payment device 8 of the identification ID is not limited to the short-range wireless communication. For example, the payment processing unit 206 may notify the payment device 8 of the identification ID via the code symbol by encoding the identification ID into a code symbol such as a two-dimensional code and displaying it on the display unit 25. In this case, the payment device 8 can acquire the identification ID from the terminal device 2 by reading the code symbol displayed on the display unit 25.

Further, for example, the payment processing unit 206 may control the communication unit 27 to transmit the identification ID of the terminal device 2 to the payment device 8 by short-range wireless communication such as Bluetooth (registered trademark). In this case, the payment device 8 acquires the sales registration data corresponding to the identification ID transmitted from the terminal device 2 from the server 4, and performs the checkout process for the registered items corresponding to the one transaction based on the acquired sales registration data.

Note that settlement of items is not necessarily performed by the payment device 8, and may be performed by the terminal device 2. For example, the payment processing unit 206 controls the display unit 25 to displays a screen capable of selecting a payment method such as electronic money payment or credit payment when receiving an operation for instructing the start of payment via the operating unit 26. When a payment method is selected, the payment processing unit 206 detects the input of the payment information for performing the payment by the selected payment method, and executes the payment process for settling the total amount of the items registered for sales based on the input payment information by cooperating with an external payment server. Such payment information may be, for example, a credit card number or a two-dimensional code for code payment. In addition, the payment processing unit 206 may detect the input of the two-dimensional code for code payment via the imaging unit 34.

Note that payment for items is not necessarily performed by the payment device 8, and may be performed by the terminal device 2. For example, the payment processing unit 206 controls the display unit 25 to display a screen for selecting a payment method such as electronic money payment or credit payment when receiving an operation for instructing the start of payment via the operating unit 26. When a payment method is selected, the payment processing unit 206 detects the input of the payment information for performing the payment by the selected payment method, and executes the payment process for settling the total amount of the items registered for sales based on the input payment information by cooperating with an external payment server. Such payment information may be, for example, a credit card number or a two-dimensional code for code payment. In addition, the payment processing unit 206 may detect the input of the two-dimensional code for code payment via the imaging unit 34.

Meanwhile, packages of items sold at stores may be changed at timing of seasonal changes, campaign execution, and the like. When a package of an item changes, the appearance feature also changes, and thus there is a possibility that the item cannot be correctly recognized. Therefore, when a package of an item is changed, an update process of reflecting the feature of the item in the collation dictionary 2422 is necessary.

However, the store or its clerks may not notice the change of the package, and the existing collation dictionary 2422 may be used without being updated. In particular, as in the present embodiment, in a sales floor moving type of checkout system, since a customer himself/herself performs item registration, the store clerks have a small chance to notice the change of the package.

Therefore, in the terminal device 2 of the present embodiment, the package recognition unit 204 executes a process for detecting an item whose package has been changed based on an item code read by the code reading unit 203.

Specifically, when an item code is read by the code reading unit 203, the package recognition unit 204 reads or acquires the collation feature of the item corresponding to the item code from the collation dictionary 2422. Next, the package recognition unit 204 compares the feature of the item extracted from the image by the package recognition with the feature for verification read from the collation dictionary 2422, thereby detecting the item whose package has been changed.

Here, when the degree of similarity between the feature of the item extracted from the image by the package recognition and the feature for the verification read from the collation dictionary 2422 is equal to or greater than a threshold value, the package recognition unit 204 determines that the package has not been changed. When the degree of similarity between the feature of the item extracted from the image by the package recognition and the feature for the verification read from the collation dictionary 2422 is less than the threshold value, the package recognition unit 204 determines that the package has been changed.

When detecting that the package has been changed, the package recognition unit 204 executes a process for notifying the corresponding item.

For example, the package recognition unit 204 outputs information including the item code read by the code reading unit 203 (hereinafter, also referred to as package change information). Here, the output of the package change information means that the package change information is transmitted to an external device in the present embodiment, but is not limited thereto, and is a concept including other output forms such as a display output, a print output, and a file output. In the present embodiment, an example in which the package change information is transmitted to the server 4 as an output destination will be described.

Further, for example, the package recognition unit 204 may include an image of the image area detected by the item area detection unit 202 (hereinafter, also simply referred to as an image area) together with the item code read by the code reading unit 203 in the package change information and control the communication unit 27 to transmit the package change information to the server 4. Further, for example, the package recognition unit 204 may include the feature extracted from the image area together with the item code read by the code reading unit 203 in the package change information and control the communication unit 27 to transmit the feature to the server 4. In this case, the item code, the image area, and/or the feature included in the package change information can be used as update data for updating the dictionary data of the item whose package has been changed. In the present embodiment, a mode in which the update data is included in the package change information and transmitted will be described.

Note that the timing of outputting the package change information is not particularly limited. For example, the package recognition unit 204 may output package change information every time an item whose package has been changed is detected. Further, the package recognition unit 204 may hold the package change information related to the item in the RAM 23 or the storage device 24 every time the item whose package has been changed is detected, and control the communication unit 27 to transmit the held package change information to the servers 4 at predetermined timings. For example, the package recognition unit 204 may control the communication unit 27 to transmit the package change information at a predetermined time, such as every hour, or at a timing when the package change is detected a predetermined number of times (for example, 10 times).

The destination of the package change information is not limited to the server 4, and may be another device. For example, the package recognition unit 204 may control the communication unit 27 to transmit the package change information to a terminal device (hereinafter, also referred to as a store clerk terminal) operated by the clerk. Further, the package recognition unit 204 may include a part (for example, an item name) or all of the item information corresponding to the item code in the package change information and control the communication unit 27 to transmit the package change information. In the case where the package change information is received, the store clerk terminal displays the item code, the image area, the item name of the item corresponding to the item code, and the like included in the package change information on the display device to notify the clerk of the item whose package has been changed.

On the other hand, as illustrated in FIG. 7, the server 4 performs the functions of an update notification reception unit 401, an update processing unit 402, and a data providing unit 403.

Those functions of the server 4 are performed by the CPU 41 of the server 4 in accordance with a program stored in the ROM 42 or the storage device 44, but the present disclosure is not limited thereto, and for example, some or all of the functions of the server 4 may be performed by hardware such as dedicated circuitry.

The update notification reception unit 401 acquires package update information transmitted from the terminal device 2 via the communication unit 45. Upon acquiring the package update information, the update notification reception unit 401 stores the update data included in the package update information in the data storage area 443.

When acquiring the package update information, the update notification reception unit 401 may control the communication unit 45 to transmit, to the store clerk terminal, a notification that the package has been updated with respect to the item corresponding to the item code included in the package update information. For example, the update notification reception unit 401 may control the communication unit 45 to transmit the received package update information to the clerk terminal.

The update processing unit 402 updates the collation dictionary 2422 related to the package recognition of the item whose package has been updated. Specifically, the update processing unit 402 performs a process for updating the correspondence relationship between the feature of the item and the item code based on the update data stored in the data storage area 443.

For example, when an image of the image area and an item code are included in the update data, the update processing unit 402 extracts the feature from the image area using the feature extraction model 4421, and updates the feature of the collation dictionary 4422 corresponding to the item code instructed by the update data based on the extracted feature. Further, for example, when feature data and an item code are included in the update data, the update processing unit 402 updates the feature of the collation dictionary 4422 corresponding to the item code instructed by the update data based on the feature instructed by the update data. The method of updating the collation dictionary 4422 is not particularly limited, and known techniques such as fine tuning in the field of machine learning can be used.

It is assumed that the updating process of the collation dictionary 4422 is performed for each item code, but the timing at which the process is performed is not particularly limited. For example, the update processing unit 402 may perform the update processing every time the update data is stored in the data storage area 443, or may perform the update processing at a predetermined timing. In the latter case, for example, the update processing unit 402 may perform the update process at a timing when a predetermined number (for example, ten) of pieces of update data of the same item code are stored in the data storage area 443. Further, for example, the update processing unit 402 may perform the update processing in response to an instruction from the store terminal.

The data providing unit 403 provides various types of data to each of the terminal devices 2. Specifically, when the update processing unit 402 updates the collation dictionary 4422, the data providing unit 403 provides each of the terminal devices 2 with the updated collation dictionary 4422. Note that the data providing unit 403 may provide the data of the difference between the existing collation dictionary 4422 and the updated collation dictionary 4422 as the new collation dictionary 4422 to each of the terminal devices 2. When the collation dictionary 4422 is provided from the data providing unit 403, the controller 200 of the terminal device 2 updates the collation dictionary 2422 of the storage device 24 based on the collation dictionary 4422.

Note that the data providing unit 403 may provide the collation dictionary 4422 to each of the terminal devices 2 at a predetermined timing even when the collation dictionary 4422 has not been updated.

In addition, the data providing unit 403 may provide the data at a predetermined time, for example, regardless of the timing at which the collation dictionary 4422 is provided. In addition, the collation dictionary 4422 may provide data in response to a request from the terminal device 2. In addition, the data providing unit 403 may provide data at a timing at which the data is updated. In addition, the data providing unit 403 may provide data in response to an instruction from the store clerk terminal.

The data providing unit 403 may also provide data other than the collation dictionary 4422 (for example, the item master 441 or the feature extraction model 4421) to each of the terminal devices 2 at a predetermined timing. In this case, the controller 200 of the terminal device 2 updates the corresponding data stored in the storage device 24 based on the data provided from the data providing unit 403.

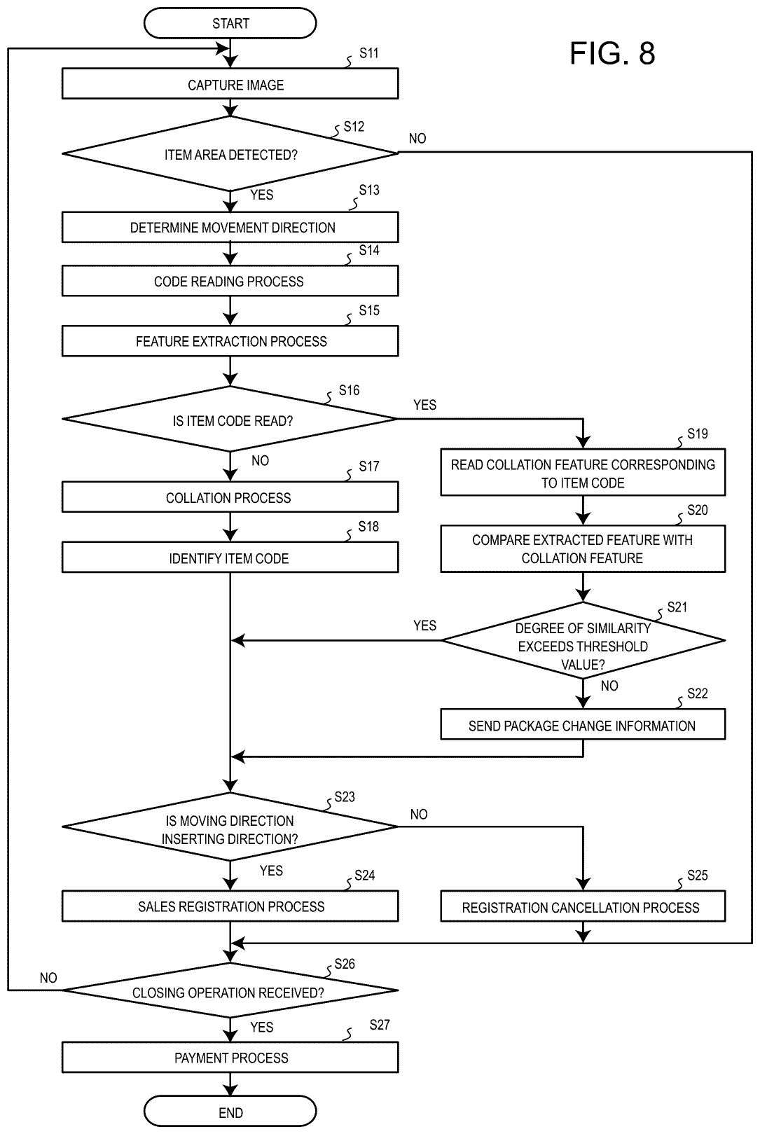

Hereinafter, an operation example of the checkout system 1 will be described. First, an example of a sales registration process performed by the terminal device 2 will be described with reference to FIG. 8. FIG. 8 is a flowchart illustrating an example of a sales registration process performed by the terminal device 2.

First, the image acquiring unit 201 of the terminal device 2 sequentially acquires the images captured by the imaging unit 34 (step S11). Next, the item area detection unit 202 determines whether an item area showing an item has been detected from the images captured in the step S11 (step S12). Here, if an item area is not detected (step S12, No), the process proceeds to step S26. Further, when an item area is detected (step S12, Yes), the item area detection unit 202 determines the moving direction of the item shown in the item area from the images continuously acquired in time series (step S13).

Subsequently, the code reading unit 203 executes a code reading process of reading a code symbol representing an item code from the item area detected by the item area detection unit 202 (step S14). Further, the package recognition unit 204 executes a feature extracting process of extracting a feature from the item area detected by the item area detection unit 202 (step S15).

Subsequently, the package recognition unit 204 determines whether an item code has been read in the code reading process of the step S14 (step S16). Here, when an item code is not read (step S16, No), the package recognition unit 204 executes a collation process of collating the features extracted in the feature extracting processing of the step S17 with the features of the respective items registered in the collation dictionary 2422 (step S17). After the collation process, the package recognition unit 204 identifies the item code of the item whose similarity exceeds a threshold value (step S18), the process proceeds to step S23.

On the other hand, when it is determined in step S16 that the item code has been read (step S16, Yes), the package recognition unit 204 reads and acquires the collation feature of the item corresponding to the item code from the collation dictionary 2422 (step S19). Next, the package recognition unit 204 compares the feature extracted by the feature extracting processing in step S15 with the collation feature read in step S19 to calculate the degree of similarity (step S20). Next, the package recognition unit 204 determines whether the calculated degree of similarity exceeds the threshold value (step S21).

Here, when the degree of similarity exceeds the threshold value (step S21, Yes), the package recognition unit 204 determines that the package is not changed, and proceeds to step S23.

When the degree of similarity is equal to or less than the threshold value (step S21, No), the package recognition unit 204 determines that an item whose package has been changed has been detected. In this case, the package recognition unit 204 controls the communication unit 27 to transmit the package change information including the item code read in the step S14, the image of the item area detected in the step S12, and the like to the server 4 (step S22), and proceeds to step S23. When receiving the package change information from the terminal device 2, the update notification reception unit 401 of the server 4 stores the received package change information in the data storage area 443.

In the subsequent step S23, the registering unit 205 determines whether the moving direction determined in the step S13 is the inserting direction or the removal direction (step S23).

Here, when the moving direction is the inserting direction (step S23, Yes), the registration unit 205 executes the sales registration process of registering the item corresponding to the item code in the sales registration table 243 based on the item code acquired in the step S14 or the step S18 (step S24). In addition, when the moving direction is the removal direction (step S23, No), the registration unit 205 executes a registration cancellation process of deleting the item corresponding to the item code acquired in step S14 or step S18 from the sales registration table 243 (step S25).

Subsequently, the registration unit 205 (or the payment processing unit 206) determines whether a closing operation has been received (step S26). Here, if the closing operation is not received (step S26, No), the process returns to step S11. When the closing operation is received (step S26, Yes), the payment processing unit 206 executes a process for payment of the item registered in the sales registration table 243 (step S27).

As a result, in the terminal device 2, it is possible to perform the item registration and the registration cancellation process of the item by using either one of the item code read from the code symbol and the item code specified from the appearance feature of the item. In addition, in the terminal device 2, it is possible to perform detection processing of an item whose package has been changed in a process of performing sales registration of an item or cancellation processing of registration.

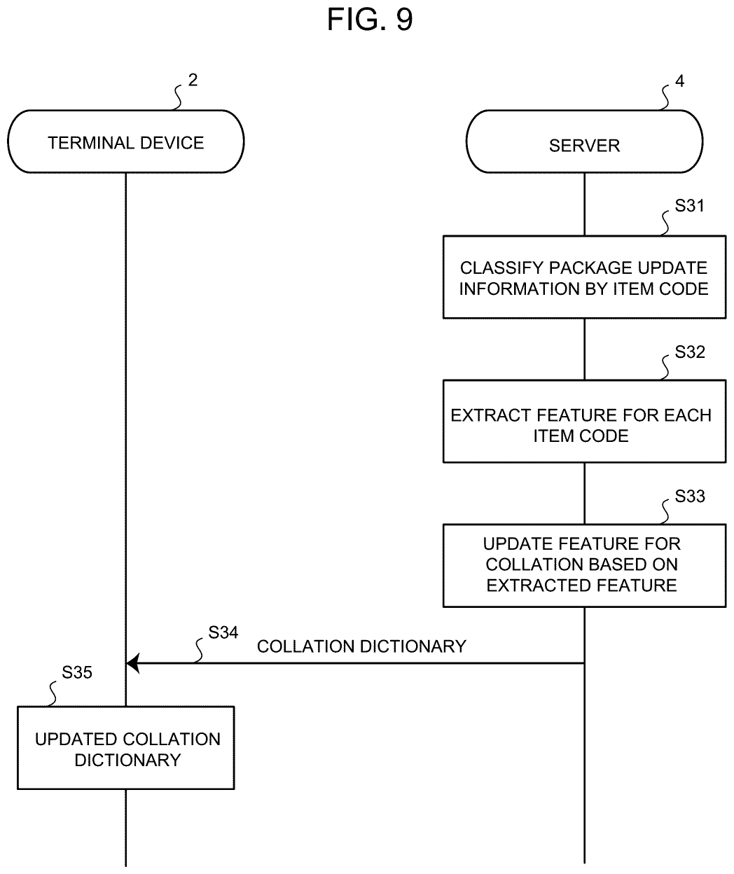

Next, an example of a data update process performed between the terminal device 2 and the server 4 will be described with reference to FIG. 9. FIG. 9 is a sequence diagram illustrating an example of a data update process performed by the terminal device 2 and the server 4. It is assumed that package change information is stored in the data storage area 443 of the server 4. Further, it is assumed that the package change information includes an image of an item area and an item code.

First, the update processing unit 402 of the server 4 classifies the package update information stored in the data storage area 443 for each type of the item code included in the package information (step S31). Next, the update processing unit 402 extracts the feature quantity related to the item code of the classification from the item area included in the classified package change information (step S32). Next, the update processing unit 402 updates the matching feature of the collation dictionary 4422 registered in association with the item code based on the set of the feature extracted in the step S32 and the classified item code (step S33).

Subsequently, the data providing unit 403 provides the updated collation dictionary 4422 to each of the terminal devices 2 (step S34). On the other hand, when the collation dictionary 4422 is received from the server 4, the controller 200 of the terminal device 2 updates the collation dictionary 2422 based on the collation dictionary 4422 (step S35).

Thus, in each of the terminal devices 2, the package recognition processing can be performed using the updated collation dictionary 2422 reflecting the feature of the item whose package has been updated.

As described above, the terminal device 2 of the present embodiment acquires the item code from the code symbol attached to the item, and acquires the feature from the image obtained by capturing the item. Further, the terminal device 2 acquires, for each of the plurality of items, the collation feature of the item corresponding to the item code read from the code symbol from the collation dictionary 2422 in which the item code of the item and the collation feature are associated with each other, and compares the collation feature with the feature acquired from the image, thereby executing a process for detecting the item whose appearance is changed. Thus, in the terminal device 2, by comparing the feature derived from the image of the item related to the same item code with the feature for matching in the collation dictionary 2422, it is possible to efficiently detect the item whose package has been changed from the similarity of the feature.

When the degree of similarity between the image-derived feature of the item related to the same item code and the collation feature of the collation dictionary 2422 becomes equal to or smaller than the threshold value, the terminal device 2 detects the item as an item whose appearance has been changed. Accordingly, in the terminal device 2, it is possible to identify an item whose appearance feature have changed, and thus it is possible to efficiently detect an item whose package has been changed.

In addition, when detecting an item whose package has been changed, the terminal device 2 outputs package change information including an item code of the item. As a result, the terminal device 2 can notify the output destination device of the item for which the package has been changed, and thus can support measures such as updating of the dictionary data, for example.

In addition, when detecting an item whose package has been changed, the terminal device 2 outputs package update information including an item code of the item and an image of an item area including the item. As a result, the terminal device 2 can provide the output destination device with data that can be used for updating the dictionary data with respect to the item that has detected the change of the package, so that the update support of the dictionary data can be performed.

In addition, since the terminal device 2 performs a process of detecting an item whose package has been changed in a process in which the customer performs item registration or registration cancellation of the item, it is possible to omit the confirmation work of the package by the clerk. Further, the terminal device 2 can acquire or collect data that can be used for updating the dictionary data in each of the terminal devices 2, so that it is possible to efficiently support the updating of the dictionary data.

It should be noted that the above-described embodiments can be modified and implemented as appropriate by changing a part of the configuration or function of each of the above-described apparatuses. Therefore, in the following, some modifications according to the above-described embodiments will be described as other embodiments. Note that, in the following, differences from the above-described embodiments will be mainly described, and detailed descriptions of the same points as those described above will be omitted. Further, the modification examples described below may be implemented individually or in combination as appropriate.

### (Modification 1)

In the above-described embodiments, the terminal device 2 attached to the cart 3 has been described, but the form of the terminal device 2 is not limited thereto. For example, the terminal device 2 may be a portable terminal such as a smartphone carried by a customer, or a portable terminal such as a smartphone or a tablet terminal lent to a customer by a store.

In this case, the terminal device 2 may cooperate with the cart 3 by performing wired or wireless communication with the imaging unit 34, or may be independent of the cart 3. In the latter case, the customer can perform registration of an item by imaging the item with the camera included in the terminal device 2. In addition, when canceling registration, the customer selects an item to be canceled from the registered items displayed in the list on the screen of the terminal device 2.

### (Modification 2)

In the above-described embodiments, the terminal device 2 performs the package recognition process, but the configuration is not limited thereto, and may be performed by an external device for the package recognition process.

In this case, the package recognition unit 204 of the terminal device 2 performs the same functions as those of the above-described embodiments by cooperating with an external device for the package recognition process. Specifically, the package recognition unit 204 controls the communication unit 27 to transmit the image of the image area detected by the item area detection unit 202 to an external device for the package recognition process, thereby causing the external device to execute the package recognition process, and acquires the processing result of the package recognition process, that is, the recognition result of the item from the external device.

Further, before acquiring the recognition result from the external device, when the item code is read by the code reading unit 203, the package recognition unit 204 notifies the external device of the item code, thereby instructing the external device to compare the feature extracted from the image area with the feature for collation related to the notified item code. In this case, the package recognition unit 204 acquires the comparison result, that is, the degree of similarity from the external device, and determines whether the degree of similarity exceeds a threshold value. When the degree of similarity is equal to or less than the threshold value, the package recognition unit 204 may generate package update information including an image of the image area and the item code and control the communication unit 27 to transmit the package update information to the server 4 or the store clerk terminal.

In the configuration of this modification, since the external device includes the item recognition data 242, the collation dictionary 2422 of the external device is updated using the collation dictionary 4422 updated by the server 4.

Thus, in the checkout system 1 according to the present modification, since the external device performs the package recognition process, the processing load of the terminal device 2 can be reduced, and the same effects as those of the above-described embodiments can be obtained.

In addition, in the checkout system 1 according to the present modification, since the external device can collectively execute the package recognition process related to the plurality of terminal devices 2, the improvement in the accuracy of the package recognition process can be reflected in the plurality of terminal devices 2 by updating the collation dictionary 2422 of the external device. Therefore, in the checkout system 1 according to the present modification, it is possible to improve the efficiency of the management of the collation dictionary 2422.

### (Modification 3)

In the above-described embodiments, a code symbol representing an item code attached to the item is read from an image captured by the imaging unit 34, but the present disclosure is not limited thereto, and for example, a code reading device specialized for reading code symbols may be used.

In this case, the code reading device may be built in the terminal device 2 or may be connected to the terminal device 2 by wire or wirelessly. In addition, the code reading unit 203 of the terminal device 2 cooperates with the code reading device to acquire information (for example, an item code) of a code symbol read by the code reading device.

Thus, in the checkout system 1 according to the present modification, even in a configuration in which the code symbol is read by using the code reading device, the same effects as those of the above-described embodiments can be obtained.

One or more programs executed by each of the devices of the above-described embodiments and modifications are stored in advance in the ROM, the storage device, or the like. Such programs may be copied and installed from a non-transitory computer-readable recording medium such as a CD-ROM, a flexible disk (FD), or a CD-R, a Digital Versatile Disk (DVD).

Further, the programs executed by each device of the above-described embodiments and modifications may be stored in a computer connected to a network such as the Internet, and may be downloaded via the network. Further, the programs executed by each device of the above-described embodiments and modifications may be provided or distributed via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A point-of-sale (POS) terminal, comprising:
an interface circuit connectable to an imaging device;
a memory that stores feature data representing a feature of an image of each of items that are sold in a store, the feature data being associated with an item code of said each of items; and
a processor configured to:
control the imaging device to capture an image,
perform a code reading process on the image to read an item code of an item shown in the image,
perform feature extraction on the image to acquire first feature data representing a feature of the item shown in the image,
search the memory for second feature data that is associated with the read item code,
based on a difference between the first and second feature data, determine whether a package of the item was changed since the second feature data was stored in the memory,
upon determining that the package of the item was not changed, register the item for purchase, and
upon determining that the package of the item was changed, issue a notification.

2. The POS terminal according to claim 1, wherein the processor determines that the package of the item was changed when a degree of similarity of the first and second feature data is less than a threshold.

3. The POS terminal according to claim 1, further comprising:
a network interface connectable to an external device, wherein
the processor is configured to:
after determining that the package of the item was changed, generate information including the item code, and
control the network interface to transmit the generated information to the external device.

4. The POS terminal according to claim 3, wherein the processor is configured to include data of the image in the information.

5. The POS terminal according to claim 3, wherein the external device is one of a store server and a store clerk terminal that are installed in the store.

6. The POS terminal according to claim 1, further comprising:
an input device, wherein
the processor is configured to, upon input of a closing operation via the input device, perform a payment process for the registered item.

7. The POS terminal according to claim 6, further comprising:
a display device, wherein
the processor is configured to, in the payment process:
generate a payment code that represents the registered item and is readable by a payment device through which payment can be performed, and
control the display device to display the payment code.

8. The POS terminal according to claim 7, further comprising:
a network interface connectable to a server, wherein
the processor is configured to, in the payment process, control the network interface to transmit information indicating the registered item to the server.

9. The POS terminal according to claim 1, further comprising:
a cart including a handle to which the imaging device is attachable.

10. The POS terminal according to claim 9, wherein
the cart includes a basket in which an item can be stored, and
the imaging device faces the basket such that an image of an item can be captured.

11. A method performed by a point-of-sale (POS) terminal, the method comprising:
storing, in a memory, feature data representing a feature of an image of each of items that are sold in a store, the feature data being associated with an item code of said each of items;
controlling an imaging device to capture an image;
performing a code reading process on the image to read an item code of an item shown in the image;
performing feature extraction on the image to acquire first feature data representing a feature of the item shown in the image;
searching the memory for second feature data that is associated with the read item code;
based on a difference between the first and second feature data, determining whether a package of the item was changed since the second feature data was stored in the memory;
upon determining that the package of the item was not changed, registering the item for purchase; and
upon determining that the package of the item was changed, issuing a notification.

12. The method according to claim 11, wherein the package of the item is determined to have been changed when a degree of similarity of the first and second feature data is less than a threshold.

13. The method according to claim 11, further comprising:
after determining that the package of the item was changed,
generating information including the item code, and
transmitting the generated information to an external device.

14. The method according to claim 13, further comprising:
including data of the image in the information.

15. The method according to claim 13, wherein the external device is one of a store server and a store clerk terminal that are installed in the store.

16. The method according to claim 11, further comprising:
receiving a closing operation via an input device, and performing a payment process for the registered item.

17. The method according to claim 16, wherein the payment process includes:
generating a payment code that represents the registered item and is readable by a payment device through which payment can be performed, and
displaying the payment code.

18. The method according to claim 17, wherein the payment process includes transmitting information indicating the registered item to a server.

19. The method according to claim 11, wherein
the POS terminal is attached to a cart including a basket and a handle, and
the imaging device is attached to the handle so as to capture an image of an item placed in the basket.

20. A non-transitory computer readable medium storing a program causing a computer to execute a method comprising:
storing, in a memory, feature data representing a feature of an image of each of items that are sold in a store, the feature data being associated with an item code of said each of items;
controlling an imaging device to capture an image;
performing a code reading process on the image to read an item code of an item shown in the image;
performing feature extraction on the image to acquire first feature data representing a feature of the item shown in the image;
searching the memory for second feature data that is associated with the read item code;
based on a difference between the first and second feature data, determining whether a package of the item was changed since the second feature data was stored in the memory;
upon determining that the package of the item was not changed, registering the item for purchase; and
upon determining that the package of the item was changed, issuing a notification.
